(19) United States
(12) Patent Application Publication
(10) Pub. No.: US 2020/0349497 A1
(43) Pub. Date: Nov. 5, 2020

(54) SAME DAY DELIVERY SCHEDULING METHOD AND SYSTEM

(71) Applicant: UNITED STATES POSTAL SERVICE, Washington, DC (US)

(72) Inventor: Stephen M. DEARING, Herndon, VA (US)

(21) Appl. No.: 16/866,448

(22) Filed: May 4, 2020

Related U.S. Application Data
(60) Provisional application No. 62/843,535, filed on May 5, 2019.

(51) Int. Cl. G06Q 10/08

(52) U.S. Cl. CPC G06Q 10/083

(57) ABSTRACT

A method for same day shipment of a package is disclosed. The computer-implemented method includes obtaining provider data, customer data, and historical data from a plurality of data sources; obtaining current location data and current time data associated with one or more delivery providers and one or more buses; analyzing the current location data and the current time data that are obtained with respect to the provider data, the customer data, and the historical route data; determining a schedule, a first receipt location and a first receipt time for the first package; determining a first delivery provider and/or bus for the first package based on the schedule; and providing instructions to the bus and/or a first delivery provider computer device associated with the first delivery provider of the one or more delivery providers to receive, handoff, and/or deliver the first package based on the schedule.

### CROSS REFERENCE TO RELATED APPLICATIONS

This application claims benefit of priority to U.S. Provisional Application No. 62/843,535 filed on May 5, 2019, which is incorporated by reference in its entirety.

### FIELD

This application relates to package delivery, and in particular to a method and a system for scheduling packages for same day or next day delivery.

### BACKGROUND

With the ever-increasing reliance on ecommerce for shopping needs and the expectation of raid delivery, including same day or next day shipping, becoming a determinate for selection of a retailer, package carriers have had rethink and redesign their existing fulfillment processes. What is needed is an improved method and system for scheduling packages for same day or next day delivery.

### SUMMARY

According to examples of the present disclosure, a computer system, a non-transitory computer-readable medium, and a computer-implemented method for scheduling and implementing same day shipment of a first package are provided. The computer system comprises a hardware processor that executes instruction to perform the computer-implemented method and the non-transitory computer-readable medium stores instructions for executing the computer-implemented method. In various implementations, the computer-implemented method comprises obtaining, over a communications network, provider data, customer data, historical route data for one or more delivery providers from a plurality of data sources; obtaining, over the communications network, current location data and current time data associated with the one or more delivery providers and/or buses; analyzing, by one or more hardware processors, the current location data and the current time data that are obtained with respect to the provider data, the customer data, and the historical route data that are obtained using a database graph search algorithm; determining, by the one or more hardware processors, a first receipt location and a first receipt time for the first package based on the analyzing; determining, by the one or more processors, a first delivery provider and/or bus for the first package based on the schedule; and providing, over the communications network, instructions to a first delivery provider computer device associated with the first delivery provider of the one or more delivery providers or bus to receive, handoff, and/or deliver the first package based on the schedule.

In examples, the computer-implemented method can further comprise obtaining weather data from a weather data provider and traffic data from a traffic data provider and wherein the analyzing further comprises using the weather data and the traffic data in the graph search algorithm.

In examples, the computer-implemented method can further comprise continuously updating the analyzing based on updated information; determining that the first delivery provider will not be at the first receipt location at the first receipt time; and providing the instructions to a second delivery provider of the one or more delivery providers to receive or delivery the first package.

In examples, the historical route data comprises one or more routes taken by each of the one or more delivery providers. The one or more routes are segmented to a plurality of sections, wherein each of the plurality of sections associated with a start point and an end point. Each of the plurality of section is associated with a transit time to travel a length of each section.

In examples, the computer-implemented method can further comprise determining a second receipt location and a second receipt time for a second package based on the analyzing; and providing instructions to a third delivery provider of the one or more delivery providers to receive or deliver the second package based on the second receipt location and the second receipt time. The third delivery provider can be the first delivery provider.

In examples, the instructions are overlaid or integrated within a graphical representation of map associated with the first delivery location.

According to examples of the present disclosure, a computer system, a non-transitory computer-readable medium, and a computer-implemented method for delivery of packages are provided. The computer system comprises a hardware processor that executes instruction to perform the computer-implemented method and the non-transitory computer-readable medium stores instructions for executing the computer-implemented method. In various implementations, the computer-implemented method comprises method for delivery of packages is disclosed. The computer-implemented method comprises obtaining, over a communication network, delivery information for a product purchased from a retailer, wherein the delivery information comprises instructions for a local delivery of the product; preparing, by a hardware processor, packing instructions for a package containing the product for the local delivery; determining that the package can be delivered on the same day based at least one of a time at which the package was received by the customer, a location of each carrier within a service zone, weather data, traffic data, a day of the week, or a size of the package; scheduling, by the hardware processor, a pickup time, a delivery time, or both the pickup time or delivery time for the package for a first package carrier based on the determining; preparing, by the hardware processor, delivery instructions for the first package carrier to deliver the package to an exchange location or to a destination; and sending, over the communication network, the delivery instructions to a client device of the first package carrier to be displayed on a display of the client device.

According to various examples, the scheduling further comprises determining that the first package can be delivered on the same day based at least one of a time at which the first package was received by the customer, a location of each carrier within a service zone, weather data, traffic data, a day of the week, or a size of the first package. The scheduling further comprises determining that the destination for the first package is on a delivery route or a line of travel based on a geographic position of the first package carrier. The scheduling further comprising obtaining, over the communication network, geolocation data for each package carrier in a service zone. The geolocation data comprises an identifier for a delivery route, an identifier for the line of travel, a timestamp, a current global satellite coordinate for each package carrier, or a current longitude-latitude identifier for each package carrier. The geolocation data is updated on a periodic basis.

According to examples of the present disclosure, a computer system, a non-transitory computer-readable medium, and a computer-implemented method for delivery of packages are provided. The computer system comprises a hardware processor that executes instruction to perform the computer-implemented method and the non-transitory computer-readable medium stores instructions for executing the computer-implemented method. In various implementations, the computer-implemented method comprises method for delivery of packages is disclosed. The computer-implemented method comprises obtaining information for a plurality of packages to be delivered from a customer; determining, by a hardware processor, whether a volume of the plurality of packages exceeds a volume threshold for a store to handle; providing, over a communication network to a customer computer device, first drop of instructions to the customer if the volume threshold is determined to be exceeded, wherein the first drop of instructions comprise a high volume drop of location; providing, over the communication network to a first client device, pickup instructions to a first package carrier if the volume threshold is determined not to be exceeded; determining, by the hardware processor, whether a first package of the plurality of packages can be delivered on a same day the first package is picked up by the first package carrier; providing, over the communication network to the first client device, second drop of instructions to the first package carrier if the first package cannot be delivered on the same day, wherein the second drop of instructions comprise a next day delivery location for delivery of the first package on the next day; determining, by the hardware processor, whether a destination for the first package is on a delivery route or a line of travel of a first package carrier if the first package is determined to be able to delivered on the same day; providing delivering instructions, over the communication network to the first client device, for the first package to be delivered to the destination if the first package is determined to be on the delivery route or the line of travel of the first package carrier; and providing instructions, over the communication network to the first client device, to the first package carrier to deliver the first package to a drop off location to be handled to a second package carrier if the first package is determined to not be on the delivery route or the line of travel of the first package carrier.

According to various examples, the determining whether the first package can be delivered on the same day is based at least one of a time at which the first package was received by the customer, a location of each carrier within a service zone, weather data, traffic data, a day of the week, or a size of the first package. The determining whether the destination for the first package is on the delivery route or the line of travel based on a geographic position of the first package carrier. The first package is determined to not be on the delivery route or the line of travel of the first package carrier based on a geographic position of the first package carrier. The computer-implemented can further comprise obtaining, over the communication network, geolocation data for each package carrier in the service zone. The computer-implemented method can further comprise obtaining, over the communication network, geolocation data for each package carrier in adjacent service zones. The geolocation data comprises an identifier for the delivery route, an identifier for the line of travel, a timestamp, a current global satellite coordinate for each package carrier, or a current longitude-latitude identifier for each package carrier. The computer-implemented method can further comprise providing, over the communication network, the geolocation data to each client device for at least a subset of package carriers in the service zone.d

### BRIEF DESCRIPTION OF THE DRAWINGS

The accompanying drawings, which are incorporated in and constitute a part of this specification, illustrate embodiments of the present teachings and together with the description, serve to explain the principles of the disclosure.

FIG. 1 shows a computer system for providing delivery data for a package, according to examples of the present disclosure.

FIG. 2 shows a general method for same day shipment of a package, according to examples of the present disclosure.

FIG. 3 show a computer-implemented method for same day shipment of a first package, according to examples of the present disclosure.

FIG. 4 show a computer-implemented method for same day shipment of a package, according to examples of the present disclosure.

FIG. 5 shows a first map for same day delivery, according to examples of the present disclosure.

FIG. 6 shows a second map for same day delivery, according to examples of the present disclosure.

FIG. 7 illustrates an example of a hardware configuration for a computer device 700 that can be used as the server 126, which can be used to perform one or more of the processes described above.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

The system and method described herein relate to coordinating pick-up and/or delivery of items from a variety of sources, including vendors, merchants, and other retailers, including online retailers to a variety of locations, including residential locations, business locations, drop-off locations, and transportation stops. The system and method described herein also relate to coordinating the delivery of the picked up items within a specific geographical area, such as a metropolitan area, a city, or a neighborhood. In some embodiments, the system of pick-up and delivery is related to pick-up and delivery of items within a specified or pre-determined time, such as pick-up and delivery on the same day, next-day delivery, or other specified time period.

The term “bus stop,” as used herein, may refer to a geographic location where a package is picked up, dropped off, exchanged, or the like, for example between customers, delivery personal, and/or delivery vehicles.

The term “real-time” may mean that data is available to a user, either internal or external, approximately at the time that it is available or generated; for example, within from 0.01 to 20 seconds after the data is generated, such as 5 seconds, 2 seconds, 1 second, 0.5 second, or 0.1 second. The term “near real-time” may mean that the data is available shortly after it is available or generated, such as when a piece of equipment stores scan information for a time prior to making the information available. For example, a camera or scanner on item processing equipment may batch images or scans for a specified period, such as after a set number of scans, or after an elapsed time, such as every 30 seconds, every minute, every 15 minutes, or every hour.

A distribution network may comprise multiple levels. For example, a distribution network may comprise regional distribution facilities, hubs, and unit delivery facilities, or any other desired level. For example, a nationwide distribution network may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the United States Postal Service, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

In some embodiments, a distribution entity, such as a commercial carrier, the United States Postal Service (USPS), or other distributor, tracks each item throughout the distribution process. To allow for real-time tracking of items in a distribution network, each item has a unique identifier, such as a computer-readable code. In some embodiments, the computer readable code may be a barcode, an RFID tag, a QR code, an alphanumeric code, or any other desirable computer readable code, which uniquely identifies the item and/or encodes information relating to the item. Each computer-readable code may be scanned by processing equipment, carriers with mobile scanners, personnel in the distribution network facilities, transportation providers, or by other entities within the distribution chain. Scan information, which can include the computer readable code, is transmitted to and stored in a central repository.

The disclosed embodiments provide for same day scheduling systems and methods. In some embodiments, customers send information to a shipping organization (e.g., the USPS) to create an order for a new shipment. A “customer” may be an individual, a group of individuals, a business, or another type of entity that utilizes the shipping organization to deliver packages. A delivery provider may receive one or more shipped objects from the customer. For purposes of discussion, the one or more shipped objects are hereinafter referred to as a “package.” The delivery provider may dispatch the package from the origin location toward the package's designated destination. The time and route travelled by the package from the package's origin to destination can be complied as route data. The scheduling system may analyze data associated with a newly created shipment, to simulate a journey that the package will travel, and predict any possible problems to warn the customer. In some embodiments, the delivery provider may transfer the package to other entities for some, or all, of a package's journey.

In examples, the scheduling system and method uses package transportation vehicles that are dedicated for use by the scheduling system and method to create a transport network for store-to-door or door-to-door same-day delivery that leverages a preexisting workforce of delivery providers, such as USPS mail carriers, within a specified, fairly local area. In various embodiments, the dedicated package transportation vehicles may be trucks or vans or the like (such as USPS delivery vans), that drive a route, and that halt at stops to meet delivery providers, (e.g., mail carriers or package carriers or simply carriers), to offload and onload packages. The route and stops are determined by the scheduling system and method and communicated to the dedicated package transportation vehicles and to the delivery providers. In some implementations, the route and stops may be communicated dynamically and/or in real time. Because they follow scheduled routes and stops, the dedicated package transportation vehicles are analogous to public transportation buses, and as used herein, the term “bus” is used interchangeably with “dedicated package transportation vehicle.”

The disclosed scheduling system and method can supplement the existing carrier workforce with additional ingest of package volume from brick and mortar stores and the like based upon service level agreements associated with the various stores.

In various implementations, a person's orders to a brick and mortar store typically get fulfilled in the morning and then the packaged orders are ready for pickup and delivery starting at 10 o′clock and moving throughout the day. The brick and mortar store communicates this to the scheduling system, which creates a scheduled pickup for the individual carrier whose walking delivery route includes the store. The individual carriers may also pick up ad-hoc packages along their route. The disclosed system and method leverages the existing technology of carrier location data, (also known as GPS breadcrumbs), which is provided by the carrier's hand-held device to the scheduling system, so that scheduling system knows the location of an individual carrier as they're walking along their delivery routes. The disclosed system and method also leverages a network of intelligence and information based upon major transportation nodes, which are located on major transportation arteries (e.g., roads) for a particular geographic delivery area. The transportation nodes can include one or more sub nodes, which may located on secondary arteries. Depending upon the details of a particular service level agreements with an individual customer (e.g., brick and mortar store), the scheduling can be created such that a customer employee personally meets the bus at a pickup point, where the customer (store worker) personally places the package on the bus. The delivery schedule can allow schedules from the brick and mortar stores to align with a bus schedule and vice versa.

In some embodiments, the delivery schedule can be based on a scheduled route, like a fixed bus route, but the stops may change depending upon the service level agreements, which delivery provider has packages for that day, where the packages are going, etc. The delivery schedule is dynamic, and may be based on optimizing travel routes for the day, including using or avoiding major arteries in the delivery area and which brick and mortar stores have packages for that day. Also, the delivery schedule may be based on the timing of the pickup of those stores and where the delivery providers are in the delivery area, which would affect the nodes and meet and pickup points.

For example, consider a delivery provider that picks up package A at store D, picks up package B at store E, and picks up package C at store F. Based on the schedule, the delivery provider meets the bus needed for package A at meet point 1 for route two, personally delivers package B on route one via walking based upon the delivery provider's current location, and messages the recipient of package C using a mobile delivery device with text capability to rendezvous at a pickup point on the corner of Smith and Maine at 2:00 PM in order for the recipient to personally receive package C directly from the delivery provider.

The scheduling system can determine if a particular delivery provider is no longer near a delivery location or how far away the delivery provider is from a delivery location. If packages are available for pickup along a delivery provider's route, then the delivery provider may pick up those packages and put it in their vehicle. If the package is for another delivery region, the delivery provider can go to their meet point with a bus route, and can hand the packages off to another delivery provider. The calculations and dynamic scheduling takes place and generates a new schedule.

For example, when a person places an order for a product with a store, the store processes the order using their fulfillment process. The store prepares the product for shipment by addressing the package with the ordering person's (i.e., recipient's) information and a barcode for delivery. The package is put into the store's inventory of data that is sent to the delivery service (e.g., USPS) and that indicates that the package is now ready for pickup. As soon as the transaction is complete, if that transaction happens prior to the service level agreement pickup time, then the shipment is for this day. Otherwise, it may roll over to the next day. And if it's for this day, the shipment information is transmitted to a server platform, such as a cloud-based server platform, for scheduling calculation, which goes into a queue or database or the like with all of the other stores that are using the scheduling and delivery system. The scheduling of the bus is based on where the delivery providers currently are and where they will be in the future (later in the day). Because of the use of the GPS breadcrumbs, a historical perspective is provided that allows the system to accurately predict where each delivery provider is going to be at any point in time during the day.

In examples, the dynamic scheduling system segments a geographic region into delivery zones, which it further subdivides into nodes based on major or major and minor transportation arteries. A calculation of transit time for the bus can then be performed based on the nodes and the associated drive time between them to determine an optimum time and/or location for meet or pickup points. Each time parameter associated with a node can include a variable time buffer length to allow for typical delays along a travel route. In various implementations, the time value segments of the major and minor transportation arteries can be represented as data points, which the system can analyze using database graphing techniques. The database graphing techniques can be performed in real time or in near real time.

In examples, third parties or package consolidators can be employed as package collection locations where customers can send or drop off packages that are to be delivered to recipients. For example, brick and mortar stores can contract with these third parties or package consolidators to provide for a centralized package pickup location. In some examples, business partners, such as hotels or other stores, can be used as package collection points, pickup points, or meet points.

In some such examples, a post office can act like a consolidator, where the post office can receive packages at multiple times a day with the expectation that the packages are going to get delivered that day. In this example, dedicated package transportation vehicles can be positioned at the post office, which can interact with the delivery network. The scheduling system calculates meet points and schedules these vehicles from the post office to giving the packages to the delivery providers for delivery within the carrier's routes throughout the day.

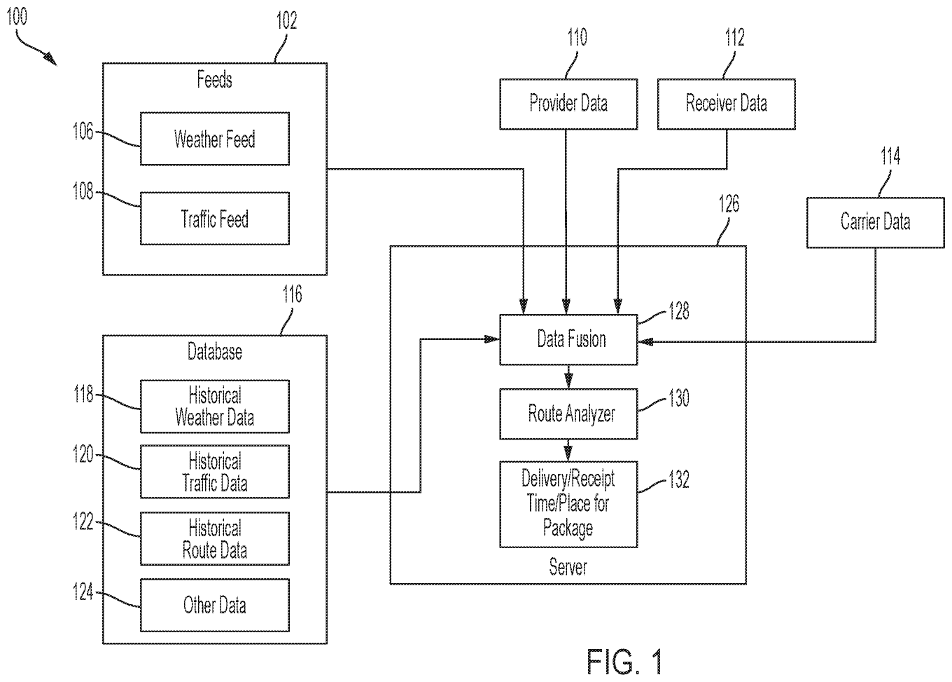

FIG. 1 shows a system 100, which may be implemented using one or more computing systems, for providing scheduling or delivery data for a package, according to examples of the present disclosure. The computer system 100 comprises a server 126 that is configured to obtain a variety of data, analyze the data using a database graphing algorithm or other suitable algorithms, and provide one or more locations and times for package receipt and/or delivery. The server 126 can include one or more hardware processors, such as one or more CPUs and graphical processing units. The server 126 can be a virtual server hosted by cloud computing service. The variety of data can comprise one or more data feeds 102. The one or more data feeds 102 can comprise a weather data feed 106 from a weather data feed provider and a traffic data feed 108 from a traffic data feed provider.

The variety of data can also comprise provider data 110, receiver data 112, and carrier data 114. The provider data 110 and/or the receiver data 112 can comprise data related to a customer (e.g., a brick and mortar store) such as, for example, account information, personal information, contact information, shipment history, statistical data such as trends or patterns derived from shipment history, and customer preferences such as preferred carriers, shipping methods, shipping speeds, and special requirements for shipments.

The carrier data 114 can include data related to delivery providers (e.g., a mail carriers) and data related to dedicated package transportation vehicles (a.k.a. buses). The carrier data 114 can include data related to transit in-progress for a customer's shipments such as, for example, delivery itinerary/schedule, time-stamped GPS data, package scan data, carrier information, transportation method, shipping speed, and information regarding delivery modifications. Carrier data 114 may also include statistical data derived regarding the route, such as trends and patterns. Carrier data 114 can also include size of the delivery fleet and/or size of a particular delivery vehicle in the delivery fleet.

The server 126 can communicate with a database 116 that can receive, store, and distribute any and all data related to methods disclosed herein. For example, database 116 may store historical weather data 118, historical traffic data 120, historical route data 122, and other relevant data 124. Historical weather data 184 can include weather data from one or more weather data sources, including, but is not limited to, the source of the weather feed 106. The historical weather data 118 can be based on one or more targeted delivery areas. Historical traffic data 120 can include traffic data from one or more traffic data sources, including, but is not limited to, the source of the traffic feed 108. The historical traffic data 120 can be based on one or more targeted delivery areas. Historical route data 122 can include data specific to one or more routes and to a carrier(s) that is associated with those one or more routes. Each route of the one or more routes may be segmented into a plurality of route segments and each of the plurality of route segments can be associated with a particular transit time to travel the distance of the plurality of route segments. Historical route data 122 can include data specific to carriers, for example, scheduling data and delay data. Scheduling and delay data may include, for example, timetables, information regarding delays, mechanical breakdowns, accidents, and cancellations. The other data 124 can include, but are not limited to, historical provider data, historical receiver data, and historical carrier data.

The data from the feeds 102, the provider data 110, receiver data 112, carrier data 114, and the database 116 are provided to a data fusion element 128 of the server 126. The data fusion element 128 can include one or more algorithms that can combine, aggregate, and/or sample data from the variety of data sources. A route analyzer 130 of the server 126 can obtain the output from the data fusion element 128. The route analyzer 130 can include one or more algorithms that can determine one or more appropriate routes for a bus(es) and/or for a carrier(s) that can be used to receive a package from a customer and/or determine one or more appropriate routes that can be used to deliver the package to a recipient. In one non-limiting example, an algorithm of the one or more algorithms to determine an appropriate route is a trained neural network that employs database graphing to determine an optimum or near-optimum route, which may be based on one or more predefined rules. The one or more rules can be based on one or more factors including, but are not limited to, the service-level agreement with a particular customer (e.g., provider of the package) that guarantees a standard of handling of the package, i.e., time of delivery, handling of the package, proof of receive or delivery of package, etc. The results of the route analyzer 130 are provided to delivery/receipt time/place for the package 132 where instructions are provided to a computing device of the delivery provider and/or to computing device on the bus (or with the driver of the bus) to receive or deliver the package.

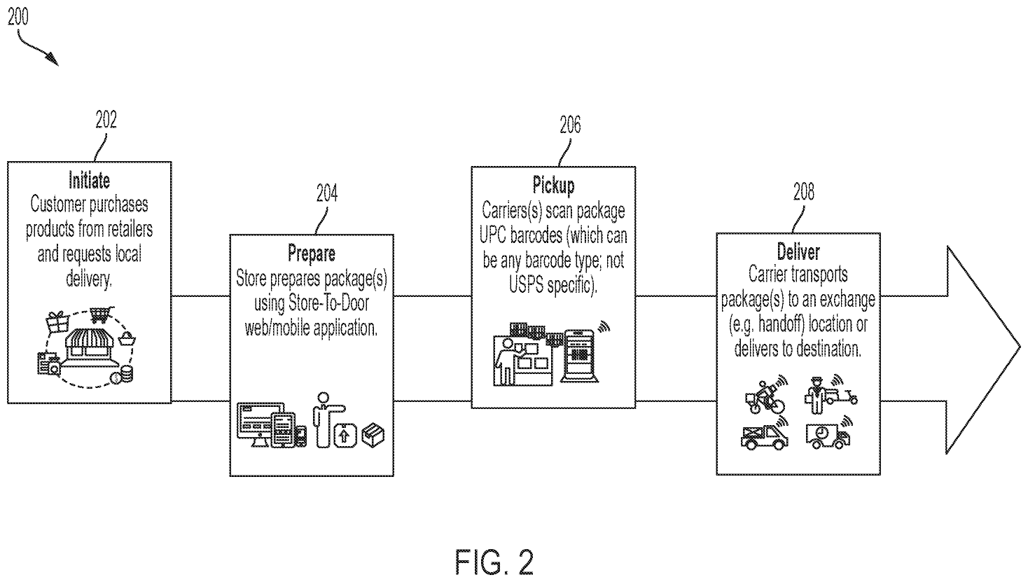

FIG. 2 shows a general method 200 for same day scheduling and shipment of a package, according to examples of the present disclosure. The method 200 comprises initiating, at 202, a scheduling and delivery. For example, a person purchases one or more products from one or more retailers, e.g., a brick and mortar retailer. During the purchasing process, the person request local delivery for one or more first products of the one or more products. The method 200 continues with preparing, at 204, the one or more first products for delivery. Continuing with the example, a first retailer of the one or more retailers prepares the one or more packages for the one or more first products using a web/mobile computer application, such as a store-to-door application. The method 200 continues with picking-up, at 206, the one or more packages by a delivery provider. Continuing with the example, one or more delivery providers, e.g., carrier(s), scans the one or more packages' respective barcodes, i.e., UPC barcodes, or gathers delivery information using some other similar digital tagging and tracking product or technique. The method 200 continues with delivery, at 208, of the one or more packages. Continuing with the example, the one or more delivery providers transport the one or more packages to an exchange location, (e.g., handoff or meet point), or delivers the one or more packages to the delivery destination.

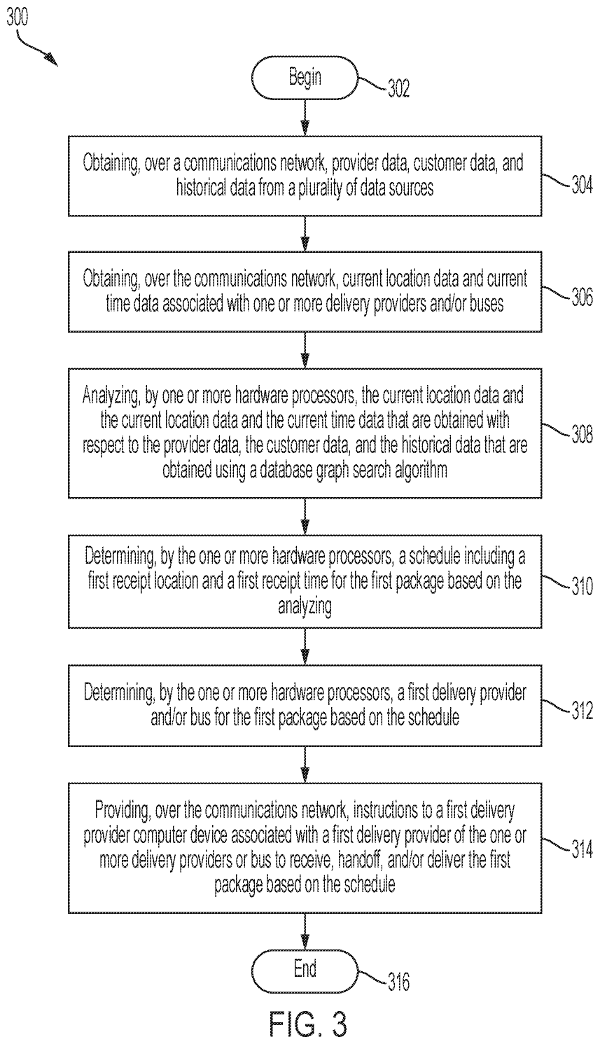

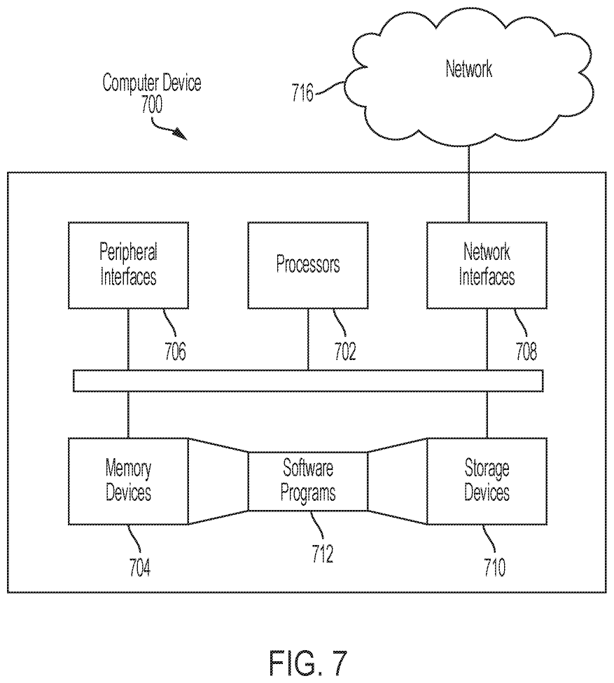

FIG. 3 show an example of a computer-implemented method 300 for same day shipment of a first package, according to examples of the present disclosure. The computer-implemented method 300 begins at 302 and continues at 304 by obtaining, over a communications network, provider data, customer data, and historical data from a plurality of data sources. For example, returning to FIG. 1, the provider data is obtained from provider data 110, the customer data is obtained from receiver data 112, and the historical data is obtained from database 116. The computer-implemented method 300 continues at 306 by obtaining, over the communications network, current location data and current time data associated with one or more delivery providers and one or more buses. Continuing with the example, the current location data and the current time data are obtained from carrier data 114. The computer-implemented method 300 continues at 308 by analyzing, by one or more hardware processors, the current location data and the current time data that are obtained with respect to the provider data, the customer data, and the historical route data that are obtained using a graph search algorithm. Continuing with the example, the server 126 processes the data obtained from the various data sources using a hardware processor (as shown and described with relation to FIG. 7 below). The computer-implemented method 300 continues at 310 by determining, by the one or more hardware processors, a schedule, a first receipt location and a first receipt time for the first package based on the analyzing. Continuing with the example, the server 126 processes the data from the various data sources and performs a route analysis using route analyzer 130 to determine the schedule. The computer-implemented method 300 continues at 312 by determining, by the one or more hardware processors, a first delivery provider and/or bus for the first package based on the schedule. Continuing with the example, the server 126, based on the route analyzer, determines a carrier to use to deliver the package. The computer-implemented method 300 continues at 314 by providing, over the communications network, instructions to the bus and/or a first delivery provider computer device associated with the first delivery provider of the one or more delivery providers to receive, handoff, and/or deliver the first package based on the schedule. The computer-implemented method 300 can end at 316.

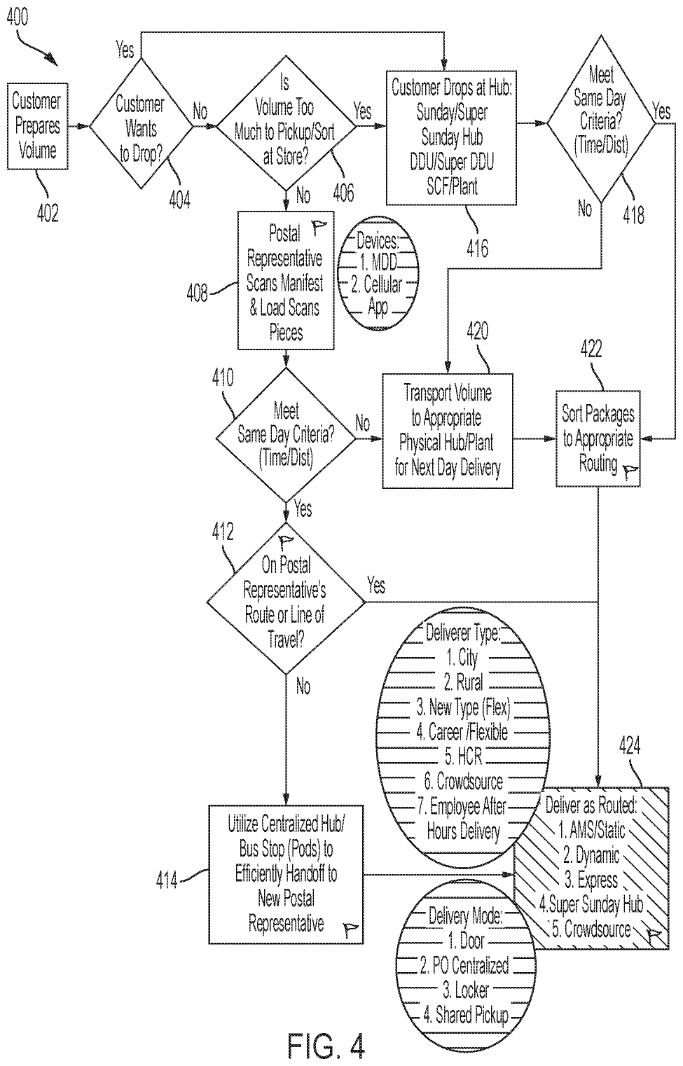

FIG. 4 show a computer-implemented method 400 for same day scheduling and shipment of a package, according to examples of the present disclosure. The computer-implemented method 400 begins at 402 where a customer prepares a volume. The computer-implemented method 400 continues by determining, at 404, whether the customer wants to drop. If the result of the determination at 404 is negative, the computer-implemented method 400 proceeds to 406 where a determination is made as to whether the volume is too much to pickup/sort at the store. If the results of the determination at 406 is negative, then the computer-implemented method 400 proceeds to 408 where a postal representative scans a manifest and loads scanned pieces. For example, the postal representative can use a mobile computing device (e.g., MDD) with an application to scan a barcode on the packages, save the tracking data, and upload the tracking data to a centralized or decentralized storage platform. The computer-implemented method 400 proceeds from 408 to 410 where a determination is made as to whether the packages can be delivered while meeting a same day delivery criteria. If the result of the determination at 410 is positive, then the computer-implemented method 400 proceeds to 412 where a determination is made as to whether the receipt location is on a postal representative's route or is located on a line of travel. If the results of the determination at 412 is negative, then the computer-implemented method 400 proceeds to 414 where a centralized hub/bus stop (pods) are used to efficiently handoff to a new postal representative.

If the results of the determination at 404 is positive or the results of the determination at 406 is positive, the computer-implemented method proceeds to 416 where the customer drop the package at a hub. The computer-implemented method 400 then proceeds from 416 to 418 where a determination is made as to whether the package can be delivered so as to meet the same day criteria. If the results of the determination at 418 is negative or the results of the determination at 410 is negative, then the computer-implemented method proceeds to 420 where the transport volume to appropriate physical hub/plant for next day delivery. If the results of the determination at 418 is positive or the computer-implemented method 400 is at 420, then the computer-implemented method 400 proceeds to 422 where packages are stored to appropriate routing. The computer-implemented method 400 proceeds from 414, if the results are positive, 414, or 422 to 424 where the delivery is routed. The delivery can be categorized by deliverer type, which can include city, rural, new type (flex), career/flexible, HCR, crowdsource, or employee after hours delivery. The delivery can also be categorized by delivery mode, which can include door, PO centralized, locker, or shared pickup.

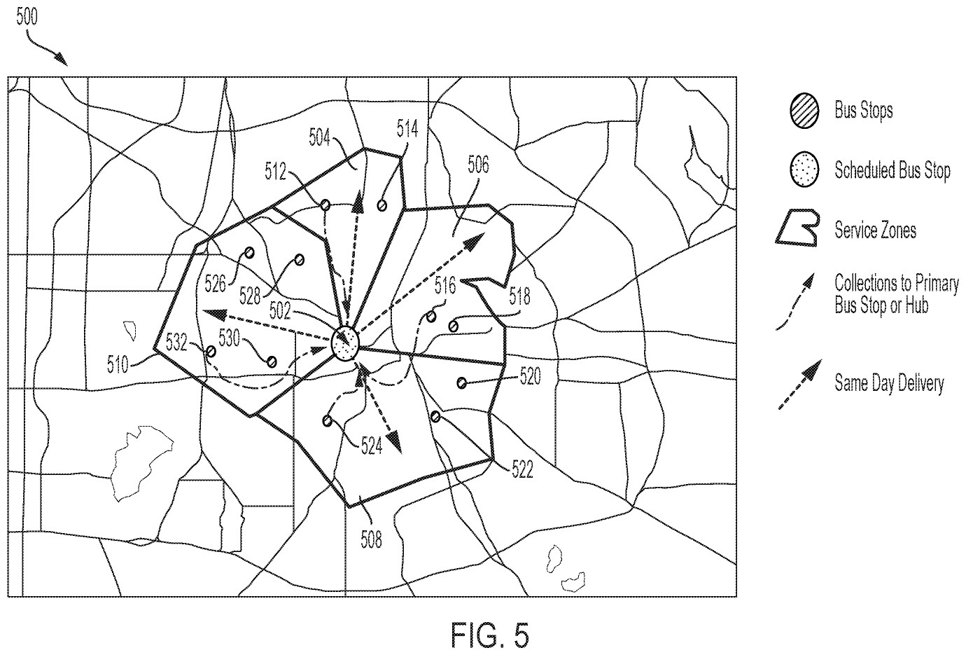

FIG. 5 shows an example of a map 500 for same day scheduling and delivery, according to examples of the present disclosure. The map 500 shows a scheduled bus stop 502 that services a plurality of service zones 504, 506, 508, and 510. Areas within the plurality of service zone 504, 506, 508, and 510 can be serviced using the same day delivery processes disclosed herein, as represented by the respective straight arrows within each zone. Each of the plurality of service zones 504, 506, 508, and 510 can include one or more dynamic bus stops, which are determined by the scheduling system as described herein. For example, service zone 504 includes bus stops 512 and 514, service zone 506 includes bus stop 516 and 518, service zone 508 includes bus stops 520, 522, and 524, and service zone 508 includes bus stops 526, 528, 530, and 532. Packages can be transported by dedicated delivery vehicles from bus stop 512, 516, 524, and 532 to the scheduled bus stop 502, as indicated by respective curved arrows. In some examples, the size of the services zones 504, 506, 508, and 510 can depend on the density of population for the particular geographic region. Areas having greater population density, can have smaller service areas for same day delivery. For example, an extent of a service zone in New York City may be set to 1 mile, whereas an extent of a service zone for a city in Iowa may be set to 50 miles.

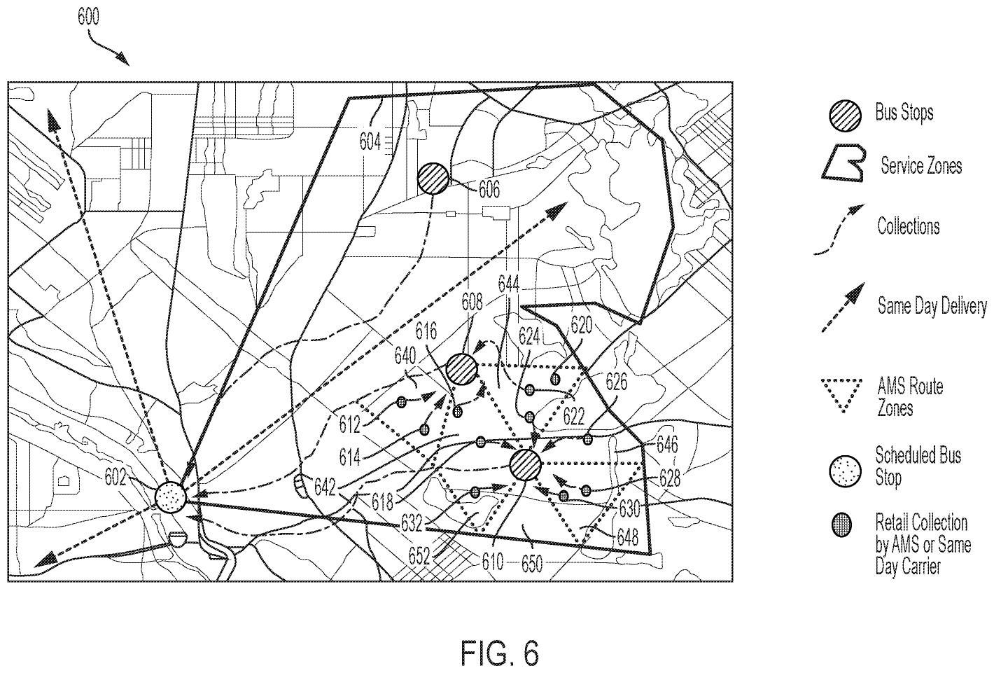

FIG. 6 shows an example of a map 600 for same day scheduling and delivery, according to examples of the present disclosure. The map 600 shows a scheduled bus stop 602 that is serviced by service zone 604. Service zone 604 comprises bus stops 606, 608, and 610. Based on package delivery requested by retail collection at points 612, 614, 616, 618, 620, 622, 624, 626, 628, 630, 632, the service zone 604 is segmented into a plurality of dynamically created route zones 640, 642, 644, 646, 648, 650, 652, as indicated by the triangles in FIG. 6. Packages at points 612 and 614 in route zone 640 are collected to bus stop 608, packages at point 616 in route zone 642 are collected to bus stop 608, packages at point 620 in route zone 644 are collected to bus stop 608, packages at point 624 in route zone 644 are collected to bus stop 610, packages at point 626 in route zone 646 are collected to bus stop 610, packages at points 628 and 630 in route zone 648 are collected to bus stop 610, and packages at point 632 in route zone 652 are collected to bus stop 610. The collection routes are shown by the curved arrows in the figure.

FIG. 7 illustrates an example of a hardware configuration for a computer device 700 that can be used as the server 126, which can be used to perform one or more of the processes described above. While FIG. 7 illustrates various components contained in the computer device 700, FIG. 7 illustrates one example of a computer device and additional components can be added and existing components can be removed.

The computer device 70 can be any type of computer or a virtual instance of a computer hosted by a cloud computing platform. As illustrated in FIG. 7, the computer device 700 can include one or more processors 702 of varying core configurations and clock frequencies. The computer device 700 can also include one or more memory devices 704 that serve as a main memory during the operation of the computer device 700. For example, during operation, a copy of the software that supports the scheduling operations can be stored in the one or more memory devices 704. The computer device 700 can also include one or more peripheral interfaces 706, such as keyboards, mice, touchpads, computer screens, touchscreens, etc. , for enabling human interaction with and manipulation of the computer device 700.

The computer device 700 can also include one or more network interfaces 708 for communicating via one or more networks, such as Ethernet adapters, wireless transceivers, or serial network components, for communicating over wired or wireless media using protocols. The computer device 700 can also include one or more storage device 710 of varying physical dimensions and storage capacities, such as flash drives, hard drives, random access memory, etc., for storing data, such as images, files, and program instructions for execution by the one or more processors 702.

Additionally, the computer device 700 can include one or more software programs 712 that enable the functionality described above. The one or more software programs 712 can include instructions that cause the one or more processors 702 to perform the processes described herein. Copies of the one or more software programs 712 can be stored in the one or more memory devices 704 and/or on in the one or more storage devices 710. Likewise, the data, for example, the super zone data, utilized by one or more software programs 712 can be stored in the one or more memory devices 704 and/or on in the one or more storage devices 710.

In implementations, the computer device 700 can communicate with other devices via a network 716. The other devices can be any types of devices as described above. The network 716 can be any type of electronic network, such as a local area network, a wide-area network, a virtual private network, the Internet, an intranet, an extranet, a public switched telephone network, an infrared network, a wireless network, and any combination thereof. The network 716 can support communications using any of a variety of commercially-available protocols, such as TCP/IP, UDP, OSI, FTP, UPnP, NFS, CIFS, AppleTalk, and the like. The network 716 can be, for example, a local area network, a wide-area network, a virtual private network, the Internet, an intranet, an extranet, a public switched telephone network, an infrared network, a wireless network, and any combination thereof.

The computer device 700 can include a variety of data stores and other memory and storage media as discussed above. These can reside in a variety of locations, such as on a storage medium local to (and/or resident in) one or more of the computers or remote from any or all of the computers across the network. In some implementations, information can reside in a storage-area network (“SAN”) familiar to those skilled in the art. Similarly, any necessary files for performing the functions attributed to the computers, servers, or other network devices may be stored locally and/or remotely, as appropriate.

In implementations, the components of the computer device 700 as described above need not be enclosed within a single enclosure or even located in close proximity to one another. Those skilled in the art will appreciate that the above-described componentry are examples only, as the computer device 700 can include any type of hardware componentry, including any necessary accompanying firmware or software, for performing the disclosed implementations. The computer device 700 can also be implemented in part or in whole by electronic circuit components or processors, such as application-specific integrated circuits (ASICs) or field-programmable gate arrays (FPGAs).

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

The foregoing description is illustrative, and variations in configuration and implementation can occur to persons skilled in the art. For instance, the various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and/or GPU and a microprocessor, a plurality of microprocessors, one or more microprocessors in conjunction with a DSP core and/or GPU core, or any other such configuration.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present embodiments. It is intended that the specification and examples be considered as examples only. The various embodiments are not necessarily mutually exclusive, as some embodiments can be combined with one or more other embodiments to form new embodiments.

While the embodiments have been illustrated respect to one or more implementations, alterations and/or modifications can be made to the illustrated examples without departing from the spirit and scope of the appended claims. In addition, while a particular feature of the embodiments may have been disclosed with respect to only one of several implementations, such feature may be combined with one or more other features of the other implementations as may be desired and advantageous for any given or particular function.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

What is claimed is:

1. A computer-implemented method for same day shipment of a first package comprising:
obtaining, over a communications network, provider data, customer data, and historical data from a plurality of data sources;
obtaining, over the communications network, current location data and current time data associated with one or more delivery providers and one or more buses;
analyzing, by one or more hardware processors, the current location data and the current time data that are obtained with respect to the provider data, the customer data, and the historical route data that are obtained using a graph search algorithm;
determining, by the one or more hardware processors, a schedule, a first receipt location and a first receipt time for the first package based on the analyzing;
determining, by the one or more hardware processors, a first delivery provider and/or bus for the first package based on the schedule; and
providing, over the communications network, instructions to the bus and/or a first delivery provider computer device associated with the first delivery provider of the one or more delivery providers to receive, handoff, and/or deliver the first package based on the schedule.

2. The computer-implemented method of claim 1, further comprising obtaining weather data from a weather data provider and traffic data from a traffic data provider and wherein the analyzing further comprises using the weather data and the traffic data in the graph search algorithm.

3. The computer-implemented method of claim 1, further comprising continuously updating the analyzing based on updated information; determining that the first delivery provider will not be at the first receipt location at the first receipt time; and providing the instructions to a second delivery provider of the one or more delivery providers to receive or delivery the first package.

4. The computer-implemented method of claim 1, wherein the historical route data comprises one or more routes taken by each of the one or more delivery providers, the one or more routes are segmented to a plurality of sections, each of the plurality of sections associated with a start point and an end point, and each of the plurality of section is associated with a transit time to travel a length of each section.

5. The computer-implemented method of claim 1, further comprising determining a second receipt location and a second receipt time for a second package based on the analyzing;
and providing instructions to a third delivery provider of the one or more delivery providers to receive or deliver the second package based on the second receipt location and the second receipt time.

6. The computer-implemented method of claim 5, wherein the instructions are overlaid or integrated within a graphical representation of map associated with the first delivery location.

7. A computer-implemented method for delivery of packages comprising:
obtaining, over a communication network, delivery information for a product purchased from a retailer, wherein the delivery information comprises instructions for a local delivery of the product;
preparing, by a hardware processor, packing instructions for a package containing the product for the local delivery;
determining that the package can be delivered on the same day based at least one of a time at which the package was received by the customer, a location of each carrier within a service zone, weather data, traffic data, a day of the week, or a size of the package;
scheduling, by the hardware processor, a pickup time, a delivery time, or both the pickup time or delivery time for the package for a first package carrier based on the determining;
preparing, by the hardware processor, delivery instructions for the first package carrier to deliver the package to an exchange location or to a destination; and
sending, over the communication network, the delivery instructions to a client device of the first package carrier to be displayed on a display of the client device.

8. The computer-implemented method of claim 7, wherein the scheduling further comprises determining that the first package can be delivered on the same day based at least one of a time at which the first package was received by the customer, a location of each carrier within a service zone, weather data, traffic data, a day of the week, or a size of the first package.

9. The computer-implemented method of claim 7, wherein the scheduling further comprises determining that the destination for the first package is on a delivery route or a line of travel based on a geographic position of the first package carrier.

10. The computer-implemented method of claim 7, wherein the scheduling further comprising obtaining, over the communication network, geolocation data for each package carrier in a service zone.

11. The computer-implemented method of claim 7, wherein the geolocation data comprises an identifier for a delivery route, an identifier for the line of travel, a timestamp, a current global satellite coordinate for each package carrier, or a current longitude-latitude identifier for each package carrier.

12. The computer-implemented method of claim 7, wherein the geolocation data is updated on a periodic basis.

13. A computer-implemented method for delivery of packages comprising:
obtaining information for a plurality of packages to be delivered from a customer;
determining, by a hardware processor, whether a volume of the plurality of packages exceeds a volume threshold for a store to handle;
providing, over a communication network to a customer computer device, first drop of instructions to the customer if the volume threshold is determined to be exceeded, wherein the first drop of instructions comprise a high volume drop of location;
providing, over the communication network to a first client device, pickup instructions to a first package carrier if the volume threshold is determined not to be exceeded;
determining, by the hardware processor, whether a first package of the plurality of packages can be delivered on a same day the first package is picked up by the first package carrier;
providing, over the communication network to the first client device, second drop of instructions to the first package carrier if the first package cannot be delivered on the same day, wherein the second drop of instructions comprise a next day delivery location for delivery of the first package on the next day;
determining, by the hardware processor, whether a destination for the first package is on a delivery route or a line of travel of a first package carrier if the first package is determined to be able to delivered on the same day;
providing delivering instructions, over the communication network to the first client device, for the first package to be delivered to the destination if the first package is determined to be on the delivery route or the line of travel of the first package carrier; and
providing instructions, over the communication network to the first client device, to the first package carrier to deliver the first package to a drop off location to be handled to a second package carrier if the first package is determined to not be on the delivery route or the line of travel of the first package carrier.

14. The computer-implemented method of claim 13, wherein the determining whether the first package can be delivered on the same day is based at least one of a time at which the first package was received by the customer, a location of each carrier within a service zone, weather data, traffic data, a day of the week, or a size of the first package.

15. The computer-implemented method of claim 13, wherein the determining whether the destination for the first package is on the delivery route or the line of travel based on a geographic position of the first package carrier.

16. The computer-implemented method of claim 13, wherein the first package is determined to not be on the delivery route or the line of travel of the first package carrier based on a geographic position of the first package carrier.

17. The computer-implemented method of claim 16, further comprising obtaining, over the communication network, geolocation data for each package carrier in the service zone.

18. The computer-implemented method of claim 17, further comprising obtaining, over the communication network, geolocation data for each package carrier in adjacent service zones.

19. The computer-implemented method of claim 17, wherein the geolocation data comprises an identifier for the delivery route, an identifier for the line of travel, a timestamp, a current global satellite coordinate for each package carrier, or a current longitude-latitude identifier for each package carrier.

20. The computer-implemented method of claim 17, further comprising providing, over the communication network, the geolocation data to each client device for at least a subset of package carriers in the service zone.
